(19) United States
(12) Patent Application Publication
(10) Pub. No.: US 2007/0043607 A1
(43) Pub. Date: Feb. 22, 2007

(54) Method to incorporate user feedback into planning with explanation

(75) Inventors: Michael D. Howard, Westlake Village, CA (US); Peter A. Tinker, West Hills, CA (US); Eric Huang, Los Angeles, CA (US)

Correspondence Address: RAYTHEON COMPANY;C/O DALY, CROWLEY, MOFFORD & DURKEE, LLP, 354A TURNPIKE STREET, SUITE 301A, CANTON, MA, 02021, US

(73) Assignee: Raytheon Company

(21) Appl. No.: 11/208,802

(22) Filed: Aug. 22, 2005

(51) Int. Cl. G06Q 99/00; G07G 1/00; G06F 17/30; H04L 9/00

(52) U.S. Cl. 705/10; 705/1; 705/80

(57) ABSTRACT

A planner generates a plan having actions based upon domain and problem definition information provided by a user. The planner stores a rationale for decisions made for each one of the series of actions. A user can query the planner to retrieve rationale information from an action. A user can modify and/or add constraints to the plan and the planner can generate a new plan using a portion of the plan affected by the new constraints.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

As is known in the art, deliberative decision-making often relies on a plan: a sequence of parameterized actions that lead from an initial state to a desired goal state. The plan breaks high-level goals into smaller goals that are more easily attained, and that together achieve the overall goal. However, producing a plan may have a limited benefit if the plan cannot be judged relative to other plans that achieve the same goals in other ways. In addition, planners that offer limited ability to alter plans may also have limited utility.

### SUMMARY OF THE INVENTION

The present invention provides methods and apparatus to generate a plan having a series of discrete actions that enhances the ability of a user to understand and/or alter the plan. With this arrangement, a user can view the plan and easily add new constraints from which a modified plan can be efficiently generated. While the invention is primarily shown and described in conjunction with generating a plan in a military environment, it is understood that the invention is applicable to a variety of domains in which it is desirable to generate a plan having actions to achieve stated goals.

In one aspect of the invention, a planner module includes a planner to sequence a series of actions to achieve stated goals based upon domain and problem definition information provided by a user. Rationale information for the actions can be stored and later accessed by a user.

In another aspect of the invention, a method of generating a plan includes parsing goal and constraint information from a user, generating a plan having a sequence of actions, storing rationales for each of the actions, and presenting the plan to the user.

In a further aspect of the invention, a system includes a planner to generate a plan having a series of actions from constraints, a plan rationale database coupled to the planner to store rationale information for the actions, and a plan store database to store zero, one, or more plans. The system further includes a decision support system coupled to the planner via an interface. The decision support system receives constraint information from which the plan is generated. The system can also include a presentation module to present the plan to the user.

### BRIEF DESCRIPTION OF THE DRAWINGS

The invention will be more fully understood from the following detailed description taken in conjunction with the accompanying drawings, in which:

FIG. 1 is a schematic depiction of a planner system in accordance with the present invention;

FIG. 1A is a schematic depiction of a planner and decision support system running on a workstation;

FIG. 1B is a is a schematic depiction of a planner system in accordance with the present invention having a planner-DSS interface over the Internet;

FIG. 2 is a flow diagram showing plan generation and modification in accordance with the present invention;

FIG. 3 is a pictorial representation of a plan display in accordance with the present invention;

FIG. 3A is a pictorial representation of a plan display at a given time;

FIG. 3B is a pictorial representation of a plan display at a given time, where the user has moved a unit to a different location, indicating a desired change in the plan; and

FIG. 4 is a pictorial representation of a side-by-side display of a plan and a modified plan.

### DETAILED DESCRIPTION OF THE INVENTION

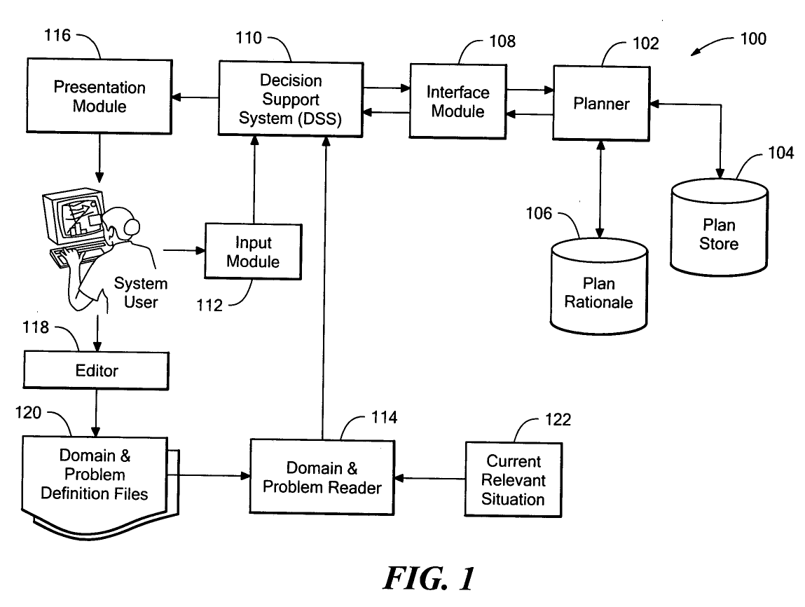

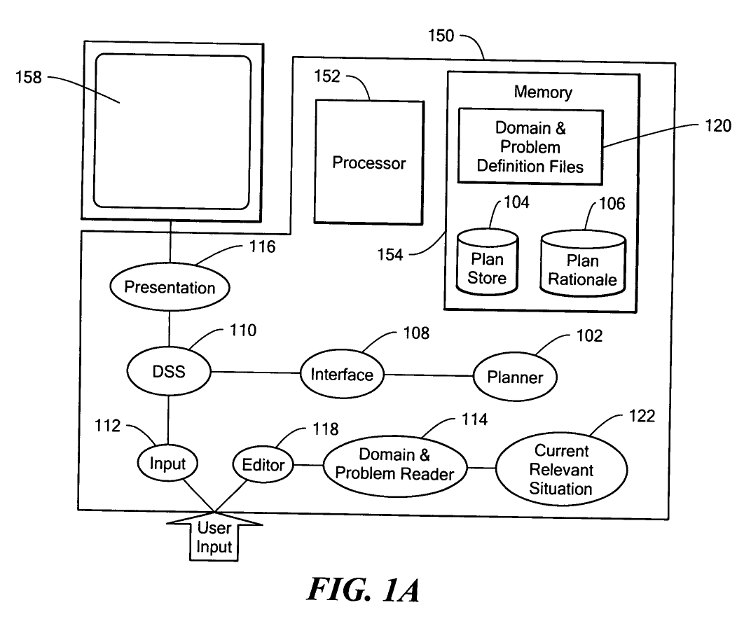

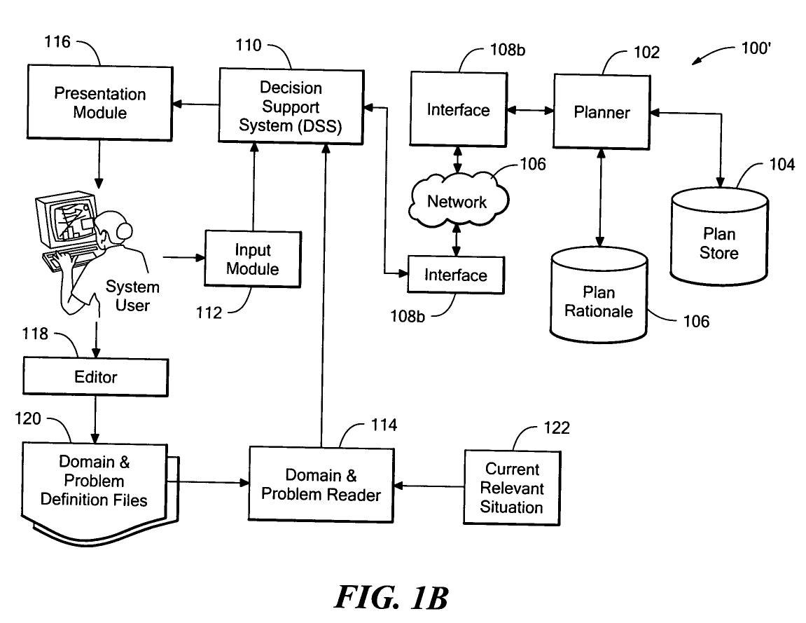

FIG. 1 shows a system 100 to generate and present a plan to a user to enable the user to readily understand and/or modify the plan. The system can enable the user to enter queries about a plan generated by the planner system. The system stores the rationale for actions and can provide this information to a user in response to a query.

In an exemplary embodiment, the system 100 includes a planner module 102 coupled to a plan store database 104 and a plan rationale database 106. An interface module 108 provides an interface between the planner and a decision support system (DSS) 110. A user provides input to the DSS 110 via an input module 112. The DSS also receives input from a domain and problem reader 114. The DSS provides information to a presentation module 116 for generating a display from which a user can see and understand the plan. The user can use an editor 118 to modify domain and problem definition files 120, which are input to the domain and problem reader 114. A current relevant situation module 122 provides information to the domain and problem reader 114, such as the state of dynamically changing variables.

In an exemplary embodiment shown in FIG. 1A, the planner module 102 is a process running on the same workstation 150 and processor 152 as the DSS 110. In an alternative embodiment, the planner module 102 runs as a service on a different machine. The workstation 150 includes memory 154, one or more CPUs, and an operating system 156 under which the planner and DSS operate. A workstation display 158 provides a means for the user to view the plan.

The interface module 108 performs data and command translation between the planner and DSS modules 102, 110 and can also buffer/connect if the modules are on different machines. The presentation module 116 generates display information to enable the plan to be represented on the user's display device. As described more fully below, the presentation module 116 can include mechanisms for enabling a user to explore the plan and ask for rationale on decisions made by the planner module 102.

The input module 112 interprets user interactions with the display as commands to the DSS module 110. The DSS 110 may in turn cause the presentation module 116 to alter the display to obtain or present more information from the user. The domain and problem definition files 120 are communicated to the DSS 110 initially by means of the domain and problem reader module 114, which may employ a variety of ways to get the information. In one embodiment, the user edits definition files in a structured format, such as the PDDL 2.1 format currently in use by the International Planning Competitions.

Current relevant situation information 122 is the current state of dynamically changing variables, such as the locations of objects relevant to the plan, current levels of numeric resources such as fuel, etc. This can be provided by analysts, filtered by some automated or human agent and used to update the system tasking.

The planner module 102 can be implemented in a variety of configurations. Various functional partitions between hardware and software will be readily apparent to one of ordinary skill in the art.

The inventive planner 102 records a rationale for each decision in the planning process. In one embodiment, upon request, the planner 102 can access the rationale for selecting or not selecting certain actions to be used in certain places in the plan. As described further below, in the interest of efficiency, in an illustrative embodiment, the planner can construct its rationale on the fly in response to a query by removing the actions indicated in the query and recording the rationale used while the planner repairs that section of the plan. In one particular embodiment, the system can operate in a second, complementary mode, in which it enables a user to modify an existing plan. The user indicates to the DSS that a part of the plan is to be changed, such as the addition, deletion, or modification of an action or fact in the plan, as described more fully below.

It is understood that the planner 102 may be tightly integrated with the DSS 110 as a module, or may be loosely connected, such by a web service. Interfaces to achieve the desired configuration are well known in the art. FIG. 1B shows an exemplary embodiment 100′ providing a planner/DSS interface over a network. A first interface 108a provides a DSS interface to the network 109 and a second interface 108b provides a planner interface to the network to connect the planner 102 and DSS 110.

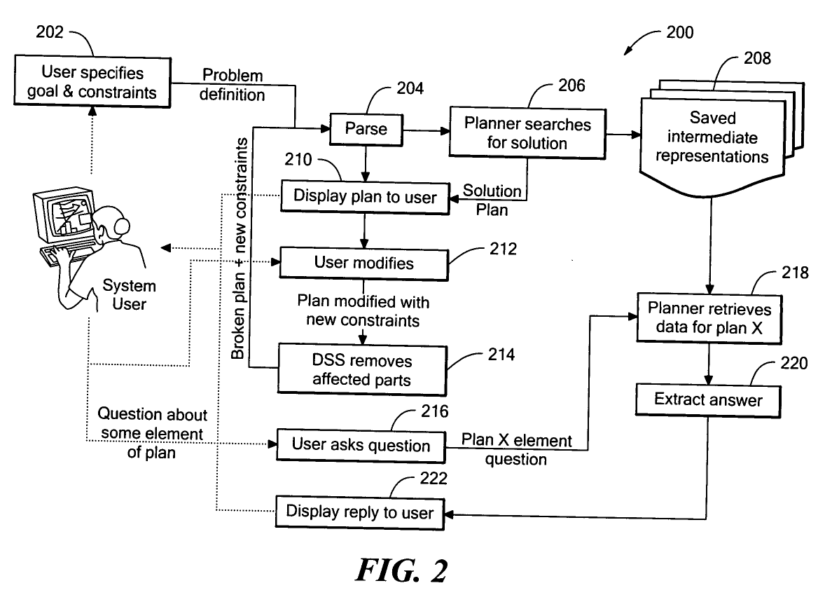

FIG. 2 shows an exemplary dataflow in the system during planning, user modifications, replanning, and subsequent explanation. For the illustrated embodiment, processes executed in the DSS are indicated with a triangle in the top right corner of the block. The parsing process executes in both the planner and DSS modules.

Processing will be described in FIG. 2 in conjunction with FIG. 1. In block 202, the user specifies a goal and constraints in achieving the goal that are provided as a problem definition to be parsed in block 204 by the planner and DSS. The goal and constraints can be included as part of the domain problem and definition files 120 in FIG. 1. After parsing, in block 206, the planner searches for a solution. In block 208, intermediate representations of the plan are saved. The resultant plan is sent from the planner to the presentation module 116 for display to a user in block 210.

In block 212, the user modifies the plan, such as via the input module 112 or using the editor 118 to modify the domain and problem definition files 120, to create new constraints. In block 214, the DSS module 110 removes the affected parts of the plan, creating a “broken” plan, and sends the broken plan with the new constraints to be parsed in block 204 by the planner and by the DSS. The planner treats the elements of the broken plan as constraints, so that actions in the broken plan are not modified, or are changed as little as possible. The planner searches for a new solution in block 206 and the updated plan is displayed in block 210. Intermediate representations of the modified plan can be saved in block 208. The user then may again modify the plan in block 212 and so on.

In block 216, a user queries the DSS regarding a particular action. The planner retrieves the data for the plan in block 218 and extracts an answer to the user query in block 220. The answer is then displayed to the user in block 222, as described more fully below.

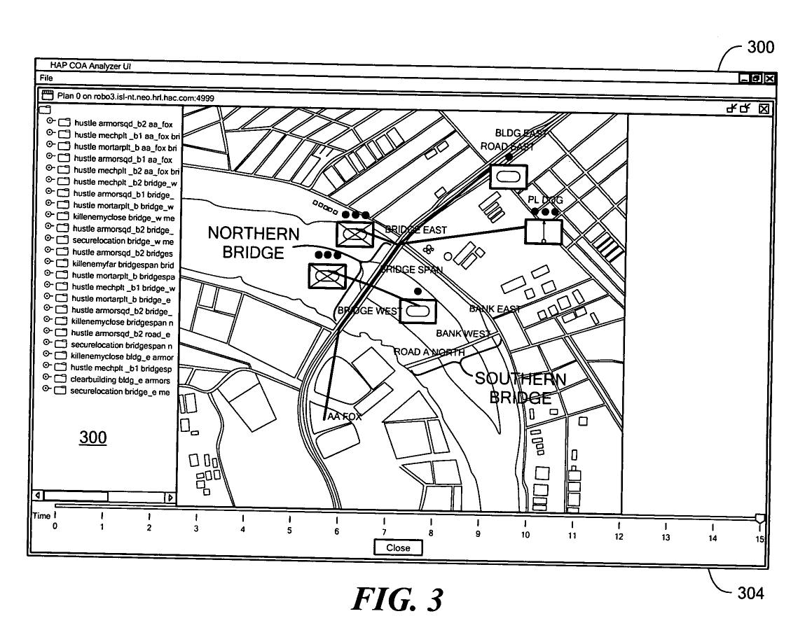

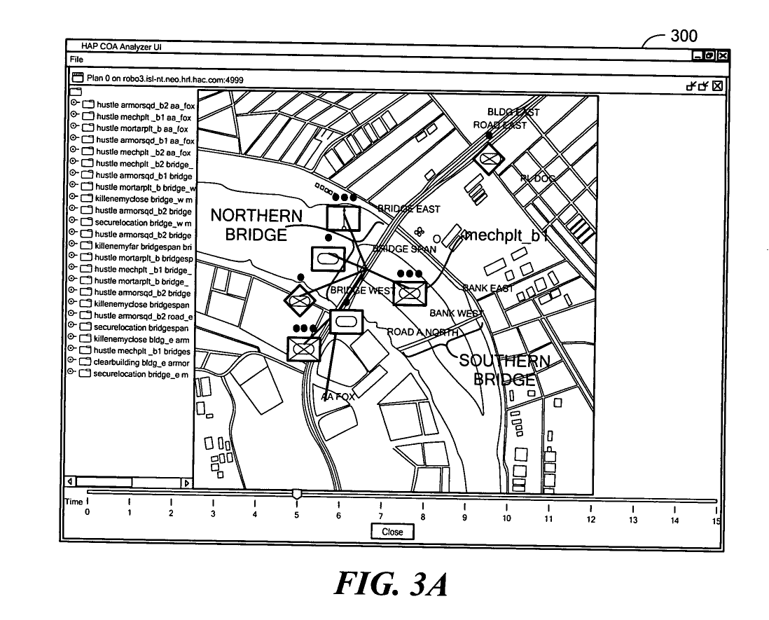

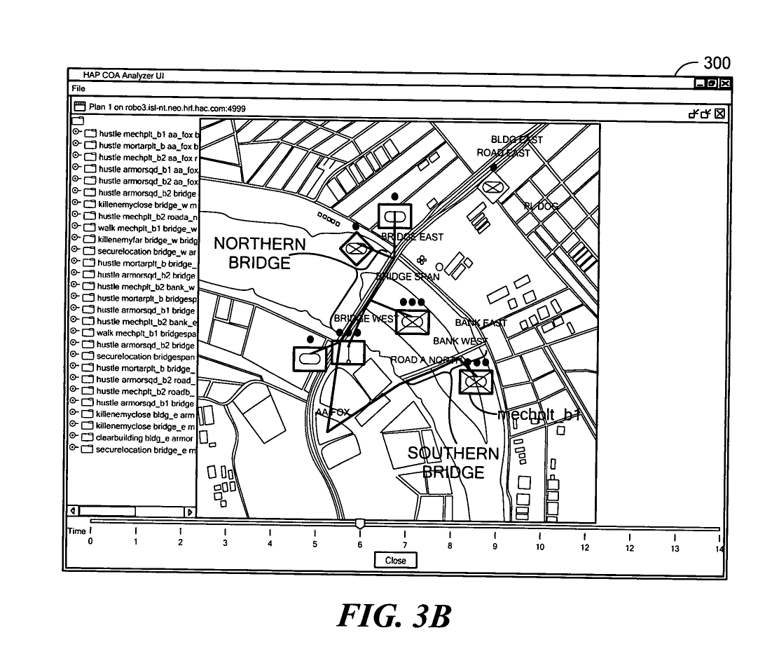

Referring now to FIG. 3, an embodiment of the invention is now described in the context of an example in which a user may express preferences in terms of specific actions to avoid and specific actions to include in the plan. Consider a problem in which a military unit, a company, must clear and occupy a northern bridge, and clear a building referred to as bldg_e (shown as BLDG EAST) in the upper right corner of a displayed map 300. The map 300 is a graphical representation of a plan, presented to the user by the DSS, where all of the units move across the northern bridge and clear the building, with a mortar platoon taking a fire support position at pl_dog just south of the building.

In an exemplary embodiment, actions in the plan are textually listed in a column 302 on the side of the map. A timeline 304 for the plan is shown as a scrollbar at the bottom of the map. When the user clicks on an action in the list on the left, the plan is displayed on the map up to the time of the indicated action, and preconditions for the actions are displayed in the list. The timeline is likewise updated to reflect that time.

It is understood that a wide variety of user interfaces are possible and readily apparent to one of ordinary skill in the art. Mechanisms other than the action list and timeline can be used to provide similar information without departing from the present invention.

In the illustrated plan, the entire company moves across the northern bridge, which is indicated on the map in terms of its component parts: BRIDGE_WEST, BRIDGE_SPAN, and BRIDGE_EAST. The user prefers, however, that unit mechplt_b1 moves across the smaller southern bridge, in a flanking maneuver.

Note that there may be many types of changes the user might want to make to the plan. Examples include changing the field of fire of a unit, changing the munition or effect, or changing the position of a unit at some point in the plan. In the illustrative example, the user changes a movement action; however, mechanisms can be used to change any parameters of any action.

In the inventive system embodiment, to make a change, the user scrolls back the displayed simulation of the plan to the time, shown as time unit 5, where the unit mechplt_b1 was crossing the bridge, as shown in FIG. 3A, and drags the unit (using a computer mouse or similar device) from its position on the bridge to the position bank_w (shown as BANKWEST) on the southern bridge. This action tells the DSS to create a new constraint that unit mechplt_b1 be required to be at that location at that time. It also tells the DSS to remove the action that put that unit at that position at that time, and all actions on which that action is dependent. An exemplary algorithm for removing the affected actions is described below. The plan that is so edited is called a “broken plan.”

When the user modifies a plan, it is not expected that the user will modify every other detail of the plan to ensure it is still consistent. This tedious work is best left to the planner. One way to do this is simply to replan ‘from scratch,’ giving the planner the new constraints so the new plan will conform to the user's wishes. However, there are several reasons for finding the minimal affected region, and replanning only that instead. For example, many planners are stochastic, and may output a different plan every time they are run with the same inputs. Second, planning is so complex that most planners are rather slow, so it makes sense not to replan parts of the plan that haven't changed.

When the user modifies the plan, the DSS gives the plan to an iterative refinement planner for repair, for example. Iterative refinement planning is known to one of ordinary skill in the art. For example, a planner known as LPG is an iterative refinement planner that can repair a plan: Gerevini, A., Saetti, A., and Serina, I. (2003). Planning through Stochastic Local Search and Temporal Action Graphs in LPG. Journal of Artificial Intelligence Research, 20, 239-290, which is incorporated herein by reference. This feature is useful since it can generate a complete plan from a partial plan. A planner such as the LPG planner operates by repeatedly selecting a plan element to improve. Broken elements like an action missing a required precondition get top priority, and the planner tries to find a way to supply that precondition. For example, looking to FIG. 3A , if the user has changed the fact (at mechplt_b1 bridgespan) at time 5 to (at mechplt_b1 bank_w) at time 6 (as in FIG. 3B), the planner would try to find a way to supply that precondition for the next action in the plan, (move mechplt_b1 bridgespan bridge_e). Most generic planners will get confused trying to make this scenario work, resulting in sometimes bizarre paths; so it is advantageous to identify and remove any action affected by the change the user has made, before replanning.

A mechanism for finding affected actions and removing them is set forth below. It is understood that alternative mechanisms will be readily apparent to one of ordinary skill in the art. As is well known in the art, a predicate is an assertion with unbound variables. When its variables are bound for a specific situation, it is called a fact, or a literal. An operator also has unbound variables; when the variables are bound for a specific situation, it is called an action. The process of binding the variables is called grounding.

The user's modifications include a set of facts F={fᵢ} that are added, deleted, or changed. If the user modifies an action, then any change in a post-condition of that action is added to F.

```
while F not empty,
  select fᵢ ∈ F and remove it from F
  A = any actions whose preconditions are dependent on fᵢ;
  A = A + any actions whose postconditions are dependent on fᵢ;
  foreach aᵢ ∈ A,
    remove aᵢ from the plan;
    add all aᵢ's preconditions to F;
  end
end
```

For example, in this case, the decision support system would remove the following actions from the plan shown in the format below as time unit: (action) [time unit differential]:

| | |
|---|---|
| 0.000 : (move mechplt_b1 aa_fox bridge_w) | [ 2.000 ] |

| | |
|---|---|
| 3.000 : (move mechplt_b1 bridge_w bridgespan) | [ 2.000 ] |
| 5.000 : (move mechplt_b1 bridgespan bridge_e) | [ 2.000 ] |

The decision support system also transforms the domain and problem into a new domain. and problem instance that contains the added constraint that mechplt_b1 must travel through the location bank_w. Specifically, the following new operator and predicate are added to the previous problem description:

```
(:action visit
    :parameters
        (?unit - blue
          ?loc - location)
    :precondition
        (at ?unit ?loc)
    :effect
        (visited ?unit ?loc)
)
(visited ?unit - force ?x - location)
```

Furthermore, the following new goal is appended to the previous goals:

(visited mechplt_b1 bank_w)

This effectively constrains the planner to produce a plan where mechplt_b1 must visit the location bank_w. The planner is then tasked with the new problem and the user is presented with the resultant graphical display of the new plan.

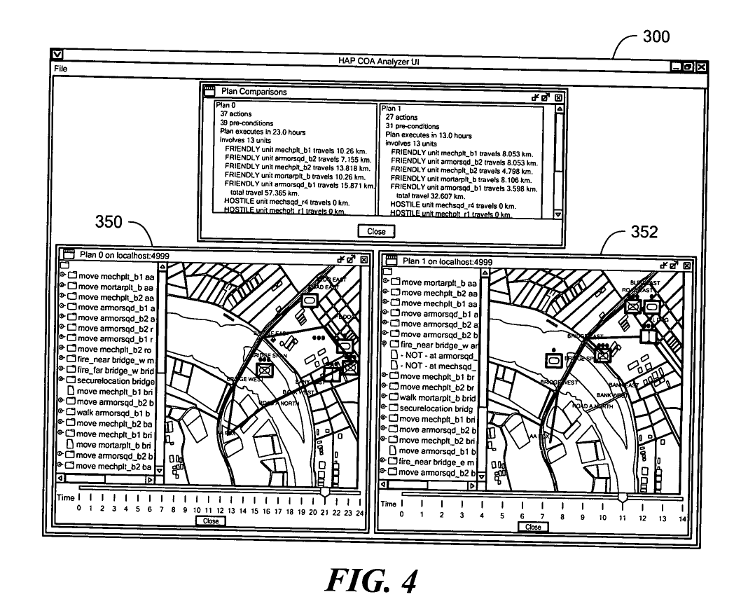

Due to the new constraint, mechplt_b1 passes through the desired waypoint, taking the appropriate southern route. As shown in FIG. 4, the new plan 352 and the original plan 350 can be shown to the user side by side, along with information about each plan, so the user can evaluate whether the new plan is preferred. Since the planner stores each plan, it can make changes to a specific plan. Therefore, the user can make other changes to either plan, and repeat the cycle.

It is understood that the procedure for adding a new constraint may be different for different types of planners. One skilled in the art will see ways to implement this in the particular type of planner they are using. As an example, this can be implemented in an iterative refinement planner, which uses a stochastic local search strategy. Without limitation, three illustrative cases are set forth below:

1. When the user changes an action, the DSS revises the current plan to change the action. It does not need to edit the problem or domain description. It should be noted that most planners pre-compile the problem and domain into an efficient, grounded form, and perform reachability analysis to speed up the search when the planning begins. For this reason, the VISITED action and predicate is added to the domain file for the original plan, in case it will be needed. The planner replans to try to fix the broken plan. One possibility is that when planning the original plan, the planner never considered that action before, and now the planner finds that the new action either improves or does not reduce the evaluation metric. In that case it will incorporate the new action as required. On the other hand, the planner may find it cannot incorporate the new action, because of conflicts with other actions or results in a lower evaluation metric. In that case the planner will return the best plan it can, and report the justification for ignoring the user's request.

2. The user could insist that the action be added to the plan, possibly after trying case 1 above and despite the planner's justification for not including it. In that case, the DSS can add a goal to perform that action (as it did with the VISITED predicate above), and the planner would replan. However, it is possible that the planner will end up changing other actions the user didn't intend to change, and in that case the new action may no longer have the same importance. The DSS presents the new plan to the user and the user can accept it as is, edit it further, or go back to the old plan.

3. The user may want to ask for the new action but this time, require the planner to “lock down” other actions to prevent the planner from eliminating or changing them through replanning. This activity can be accomplished by adding a goal for each action that should be locked, as in case 2. Different types of planners may have other ways of treating actions in the broken plan as constraints while replanning.

As noted above, planning and replanning will give more reliable results if the planner does its pre-processing and grounding of the domain and problem, and its reachability analysis, once before the first plan is created and subsequently reuses it.

Provided below are two alternate approaches to adding a goal using a mechanism like the example above of the VISITED predicate:

A. A “delta reachability analysis” would do reachability analysis on any additional actions that are needed to satisfy new goals, incrementally grounding those actions that the preprocessor might have previously pruned out while optimizing. Since only a few goals are involved, this analysis should be very fast relative to a full analysis.

B. The problem file given to the system for the original plan would include the assertion of each of the new modification predicates as goal for every possible position, every possible unit, etc. This approach would prevent the preprocessor from pruning these actions. The planner can simply turn off those goals (an easy bit operation). Since the inventive planner does a goal-oriented search, these extra actions don't slow down the computation unless they are specifically asserted in the goals—especially if the planner employs a backward search from the goals to the initial conditions. This means that any possible modification the user might choose to make is already pre-processed; the DSS just tells the planner to turn on whatever new constraints the user wants. Preprocessing is a relatively fast operation, e.g., less than a second for a moderately complex problem.

In another embodiment, a compromise solution that uses both A and B is used to create a new “anonymous” predicate X with no unbound variables. This predicate would not be included as a fact in the original problem, but rather added by the DSS “on the fly” when the user added a new constraint, and compiled using a delta reachability analysis process as in A. The preconditions of a new “anonymous” action Y are drawn from the user specifications, and X is added as Y's single postcondition. X would be a new predicate, which would be added to the problem goal list. The delta reachability analysis for this approach would be straightforward. A new uniquely named action and predicate pair are added for each user constraint.

Suppose a user wants to ensure that the specific elements satellite0, Star0, instrument0, and spectrograph6 are used in a domain concerning satellite resource allocation. Each of these is of a certain type (in the restricted computer science sense of the word). One can create a new domain with these additional types:

```
(:types satellite direction instrument mode anonymousSat - satellite
  anonymousDir - direction anonymous
  Ins - instrument
  anonymousMod - mode)
and the additional predicate:
(:predicates (anonymousPredicate1))
and the additional action
(:action anonymousAction1
  :parameters (?s - anonymousSat ?d - anonymousDir ?i -
anonymousIns ?m - anonymousMod)
  :precondition (and (= ?s ?s) (= ?d ?d) (= ?i ?i) (= ?m ?m) )
  :effect (anonymousPredicate1)
)
One can refine the problem file in this way:
(:objects
  satellite0 - anonymousSat
  Star0 - anonymousDir
  instrument0 - anonymousIns
  spectrograph6 - anonymousMod )
and refine the goals by adding anonymousPredicate1:
(:goal (and (<original goal list>) (anonymousPredicate1)))
```

This is only one set of initial facts that can instantiate the types for anonymousAction1 and thus add the postcondition (and top-level goal) anonymousPredicate1: satellite0, Star0, instrument0, and spectrograph6—just as the user indicated.

Referring again to the example shown and described in conjunction with FIGS. 3, 3A, and 3B, it may be that a platoon should visit bank_w at a certain time or at least between time1 and time2, so it can provide supporting fire from the south, for example. The DSS could supply that constraint using a timed unconditional exogenous event, for example that bank_w is “open” at time1, and “closed” at time2. Then VISITED would become VISITED_IN_TIME, where a precondition is that the location is “open”. The goal would be (visited_in_time mechplt_b1 bank_w time1 time2). Whether or not the planner can make a valid plan that achieves this would be communicated back to the user, and if not, the user would have to try something else.

Since the planner logically searches for a plan, its internal data structures can provide a rationale for why certain decisions were made during planning. It is understood that planners can employ different ways of representing this reasoning; some have internal representations that make it easier to extract meaningful rationale for the user than others. The predicate logic representation contains the logical relationships between plan elements, needed to explain the plan to the user. Take as an example the GraphPlan planner: A. Blum and M. Furst (1997). “Fast Planning Through Planning Graph Analysis”, Artificial Intelligence, 90:281-300, which is incorporated herein by reference. GraphPlan creates a “planning graph” as a by-product of the planning process. The planning graph includes actions and propositions (literals) even if mutually contradictory. A side effect of planning is marking the conflicts using “MUTEX” links. As known in the art, MUTEX refers to Mutual Exclusion, a conflict between an action and another action or fact, or between facts. Such a conflict can be caused by conflicting preconditions (e.g., one requires a fact to be true, another requires it to be false), conflicting postconditions, etc. Two such MUTEX'd actions cannot be performed at the same time.

Exemplary embodiments of the invention rely on extracting from such an internal planner representation the rationale for why certain actions were included in the plan instead of others. Other internal data that can be saved and used for rationale is the results of the heuristic the planner uses for estimating the cost of supporting an action and the distance to the goals if the action is chosen.

In one aspect of the invention noted above, the DSS can answer user questions about the plan, such as “Why was the action MOVE (UNIT1, A, B) chosen?”. If the planner was set up to exhaustively record the rationale for every decision it made while planning, the rationale for that question can be simply retrieved. But for efficiency, in an exemplary embodiment the approach is to recover only what is needed, by recreating the conditions under which the planner planned the action. That action is removed along with (possibly) any dependent actions to the end from the plan and replan, asking the planner to keep track of its reasoning. The data returned to the DSS will include each action considered at that time and why the action in question was finally selected. It is possible that a stochastic planner, as used in an exemplary embodiment, will choose a different action. In this case, the planner is configured so that it will definitely reconsider the action in question, and choose it unless some other action is found that provides a better evaluation. Any action judged to be inferior can be accompanied by an explanation, such as any MUTEX that caused it to be dropped, or simply that the evaluation function returned a lower evaluation value. For example, the user might notice that the planner had not considered MOVE(UNIT1, M, N), and could then ask “Why was MOVE (UNIT1, A, B) chosen instead of MOVE (UNIT1, M, N)?” The DSS would answer this question by removing MOVE (UNIT1, A, B) and all related actions from the plan, adding MOVE(UNIT1, M, N), and sending the broken plan back to the planner to be fixed. The user could then be shown both plans side by side along with metrics and other explanations.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A planner module, comprising:
a planner to sequence a series of actions to generate a plan based upon domain and problem definition information provided by a user, the planner storing a rationale for decisions made for each one of the series of actions.

2. The module according to claim 1, further including a plan rationale database to store the rationale.

3. The module according to claim 1, further including a plan store database coupled to the planner.

4. The module according to claim 1, further including a mechanism to provide the rationale for an action in response to a user query.

5. The module according to claim 1, further including a mechanism to enable a user to modify the plan by adding a constraint and form a modified plan.

6. The module according to claim 5, wherein the modified plan is formed from portions of the plan affected by the added constraint.

7. The module according to claim 5 wherein the mechanism includes a user interface to enable a user to modify any elements of a state of the planner at any point in the planning process for constructing one or more new constraints.

8. The module according to claim 5, wherein the planner replans only a portion of the plan affected by the added constraint.

9. The module according to claim 5, further including a mechanism to display the plan and the modified plan at the same time.

10. The module according to claim 1, further including a decision support system coupled to the planner via an interface.

11. A method, comprising:
parsing goal and constraint information from a user;
generating, by a planner, a plan having a sequence of actions;
storing rationales each of the actions; and
formatting the plan for display to the user.

12. The method according to claim 11, further including receiving a new constraint for the plan.

13. The method according to claim 12, further including removing portions of the plan affected by the new constraint.

14. The method according to claim 13, generating a modified plan.

15. The method according to claim 14, further including formatting the modified plan for simultaneous display with the plan.

16. The method according to claim 11, further including receiving a user query regarding an action and providing the stored rationale for the queried action.

17 The method according to claim 11, wherein the planner and a further planner are tasked to generate plans using different constraints, and wherein the results formatted for simultaneous display to the user.

18. The method according to claim 17, where metrics on each plan are calculated and formatted for display to the user.

19. A system, comprising:
a planner to generate a plan having a series of actions from constraints;
a plan rational database coupled to the planner to store rationale information for the actions;
a plan store database to store the plan;
a decision support system coupled to the planner via an interface, the decision support system receiving constraint information;
a presentation module to display the plan to the user.

20. The system according to claim 19, further including a plan rationale database to store rationale information for the plan actions.

21. The system according to claim 19, further including a mechanism to receive changes in the form of new constraints to the plan made by the user.

22. The system according to claim 21, wherein the decision support system removes portions of the plan affected by the new constraints, and the planner generates a modified plan.

23. The system according to claim 22, wherein presentation module can display the plan and the modified plan to the user.

24. The system according to claim 19, further including a mechanism to receive user queries and provide action rationale information in response to the query.

25. The system according to claim 19, wherein the planner and the decision support system communicate over the Internet.
